(19) United States
(12) Patent Application Publication
(10) Pub. No.: US 2020/0262415 A1
(43) Pub. Date: Aug. 20, 2020

(54) METHOD FOR WEAR PREDICTION AND MOTOR VEHICLE

(71) Applicant: AUDI AG, Ingolstadt (DE)

(72) Inventors: Andreas SCHMIDT, Altmannstein (DE); Benedikt XANDER, Ilsfeld (DE); Klaus STOLL, Ingolstadt (DE)

(73) Assignee: AUDI AG, Ingolstadt (DE)

(21) Appl. No.: 16/648,605

(22) PCT Filed: Sep. 5, 2018
(86) PCT No.: PCT/EP2018/073840

§ 371 Date: Mar. 18, 2020

(30) Foreign Application Priority Data
Sep. 29, 2017 (DE) 10 2017 217 404.8

(51) Int. Cl. B60W 20/50; B60W 20/40; H04L 12/40; G06F 17/14; H04W 4/40

(52) U.S. Cl. CPC B60W 20/50; B60W 20/40; H04L 2012/40273; G06F 17/142; H04W 4/40; H04L 12/40

(57) ABSTRACT

The disclosure relates to a method for wear prediction of a drivetrain of a motor vehicle, wherein, during operation of the motor vehicle a computing device of the motor vehicle receives at least one item of operating information describing an operating state of a component of the drivetrain, which operating information is recorded by at least one sensor of the motor vehicle and transmitted to the computing device, wherein the operating information and/or comparison information generated by using the operating information is compared to reference information stored in the computing device, wherein wear information describing wear of the component is generated depending on said comparison.

### TECHNICAL FIELD

The disclosure relates to a method for wear prediction of a drivetrain of a motor vehicle, and to a motor vehicle.

### BACKGROUND

In the case of motor vehicles, it is of interest to know the state of wear of individual components of the motor vehicle, for example in order to be able to replace worn components before they cause a defect in the motor vehicle. In particular, there is an interest in assessing the state of wear of components which are not accessible from the outside or which are not accessible, or are not readily accessible, to a visual inspection by a user of the motor vehicle. Various methods for determining wear information on vehicle components are known from the prior art.

For example, DE 10 2015 120 991 A1 shows a method and a device for wear estimation and maintenance planning for connected vehicle systems. System-wear-related data from a vehicle system usage event is received and aggregated by a processor. The system-wear-related data is also compared to data collected from vehicles for which actual wear measurements have been made to determine a projected system state of wear. If the projected state of wear exceeds an exchange limit, a system service can be recommended.

DE 10 2012 011 538 A1 describes a method and a system for the telediagnosis of vehicles, in which maintenance- and/or repair-relevant data are transmitted from a vehicle to an external computing device. Based on the transmitted maintenance and/or repair-relevant data, the computing device carries out a telediagnosis and determines maintenance and/or repair measures which can be displayed to a user.

DE 10 2011 082 361 A1 discloses a method for monitoring vehicles in a motor vehicle fleet, vehicle-related data and the geographical position of the motor vehicle being determined via a sensor system in a respective vehicle of the motor vehicle fleet. Using the vehicle-related data, a number of maintenance parameters are determined which describe the maintenance requirement of the respective vehicle. The maintenance parameters and the geographical position are transmitted to a fleet operator via a data network.

### BRIEF DESCRIPTION OF THE DRAWINGS

FIG. 1 illustrates a schematic side view of a motor vehicle in accordance with some embodiments of the disclosure.

FIG. 2 illustrates a flow chart of a first exemplary embodiment of a method in accordance with some embodiments of the disclosure.

FIG. 3 illustrates a flow chart of a second exemplary embodiment of a method in accordance with some embodiments of the disclosure.

### DETAILED DESCRIPTION

The disclosure is based on the object of specifying an improved method for wear prediction of a drivetrain of a motor vehicle.

To achieve this object, it is provided according to the disclosure that during operation of the motor vehicle a computing device of the motor vehicle receives at least one item of operating information describing an operating state of a component of the drivetrain, which operating information is recorded by at least one sensor of the motor vehicle and transmitted to the computing device, wherein the operating information and/or comparison information generated by using the operating information is compared to reference information stored in the computing device, wherein wear information describing wear of the component is generated depending on this comparison.

The advantage of the solution according to the disclosure is that wear can be determined based on actual operating data and based on actual operating states and there is no need to assume parameters that are independent of the operating state, such as set intervals of years or a mileage of the motor vehicle. The operating information obtained during the operation of the motor vehicle and describing an operating state of a component of the drivetrain serves as the basis for a comparison to reference information stored in the computing device. The operating information can be compared directly to the reference information and/or comparison information generated based on the operating information can be compared to the reference information. Wear information describing wear of the component is generated depending on the comparison of the operating information describing a current operating state to stored reference information. The wear information can indicate, for example, whether or to what extent the respective component is worn.

In this way, wear states of various components of the drivetrain of the motor vehicle, such as, for example, an engine, a clutch, a transmission, a cardan shaft, a universal shaft, a differential gear or other components used for the transmission of an engine torque to the wheels can occur. Both components of a drivetrain of a motor vehicle with an internal combustion engine and components of a motor vehicle with a hybrid drive or with a purely electric drive can be evaluated with regard to their wear.

The reference information used for the comparison can be specified, for example, by a manufacturer of the motor vehicle and can contain, for example, the data to be expected from a particular component in a specific operating state when a motor vehicle is in the new state and/or in a broken in state. It is also possible for the reference information to describe the maximum permissible operating states and/or for it to include limit values or maximum values which result from the overall operating states prevailing within a certain time frame. The operating information describing an operating state of a component of the drivetrain can be compared directly to the reference information stored in the computing unit, or comparison information can be generated based on the operating information, which information is subsequently used for the comparison to the reference information. Depending on the result of the comparison, wear information describing wear of the component is ultimately generated.

In some embodiments, the at least one item of operating information is continuously received for different points in time during operation and classified by the computing unit, summed up depending on the classification, and stored in the computing unit as load spectrum information, the load spectrum information being used as comparison information. In this way, at least one item of operating information can be received continuously for a component of the drivetrain of the motor vehicle during operation. The computing device which receives the operating information can classify it, for example depending on the magnitude of a load. Depending on this classification, the operating information can then be summed up and stored in the computing device as load spectrum information. The load spectrum information indicates which and/or how much load the component has been exposed to so far during operation. In particular, it can indicate which and/or how much load the component has been exposed to overall since it was installed in the motor vehicle. This load spectrum information can then be used as comparison information generated based on the operating information for the comparison to the reference information. It is possible that, depending on the classification, a weighted summation of the operating information is carried out, and that depending on the classification, the correspondingly classified operating information is summed up individually for each class. The different classes can describe different load areas, whereby higher loads can be weighted more heavily when combined, for example, than low loads. The classification and summation can be done separately for each item of operational information or for each monitored component.

By comparing the load spectrum information thus obtained for different components or for different operating information to the reference information stored in the computing unit, it is possible to determine for each component monitored in this way what wear there is for them due to the loads during the previous entire operation.

Furthermore, it can be provided according to the disclosure that the load spectrum information is compared to the reference information, design spectrum information describing a maximum load on the component being used as reference information. The design spectrum information can indicate which maximum load the component can withstand before such wear occurs, which necessitates a replacement of the component. The comparison of the load spectrum information to the design spectrum information describes the ratio of the current state of the component to a maximum load limit of the component. The design spectrum information can take into account both the individual classes of separately summed up load information and load spectrum information generated from jointly and weighted summed up operating information. This type of comparison between the load spectrum information and the design spectrum information advantageously makes it possible to determine the actual load on the component and to compare it to the maximum possible load, so that in particular the actual course of operation can be used to determine the total load and wear. This takes into account the fact that short-term, high loads can cause a higher overall wear of a component than a longer, but uniform and less heavy load.

In some embodiments, a frequency spectrum of a component is determined as operating information and transmitted to the computing device, a reference spectrum assigned to the operation of the component being used as reference information. The frequency spectrum can include, for example, frequencies emitted as sound during operation. The frequency spectrum of a component is transmitted to the computing device and compared to a reference spectrum assigned to the operation of the component. The reference spectrum can include different frequency spectra, which can each be assigned to different operating states of the component. Different operating states can include, for example, different speeds of the motor vehicle and/or can take into account additional parameters, such as an engaged gear or a temperature of the component. Depending on the currently prevailing operating state, a comparison can then be made between the frequency spectrum determined as operating information and the reference spectrum assigned to the currently prevailing operating state. The reference spectrum or spectra stored in the computing device can in particular describe the frequencies emitted by the respective component in the respective operating state, which occur in a normal operating state, that is to say without wear of the component. If, in the comparison between the frequency spectrum and the reference spectrum, a deviation is found between the frequency spectrum and the reference spectrum, a conclusion can be drawn about the state of wear of the component in question.

In some embodiments, the frequency spectrum of the component is determined as comparison information from a sensor signal assigned to the component by means of Fourier transformation, in particular by means of Fast Fourier Transformation (FFT), a comparison to the reference spectrum being made with respect to amplitude changes at discrete frequencies. The sensor signal can be generated, for example, by a sensor arranged on the component. The measured sensor signal can be translated by the Fourier transformation, in particular by a Fast Fourier transformation, into a frequency spectrum, which can then be compared to the reference spectrum. A comparison can be made in particular with regard to amplitude change at discrete frequencies, since such an amplitude change can indicate, for example, the change in a resonance frequency and/or the occurrence of further frequencies, for example harmonics, which can be caused by component wear. The frequency spectrum can be changed, for example, by the fact that a bearing play of a movably mounted component has increased or that a lubricant fill level has decreased, it being possible in both cases for a state of wear to exist and be detected by the method according to the disclosure.

In some embodiments, a structure-borne sound signal and/or airborne sound signal measured by a sensor assigned to the component is used as the sensor signal. For example, a microphone and/or a sensor attached to a housing of the component or to the component itself, for example an acceleration sensor, can be used as the sensor.

In some embodiments, the at least one item of operating information is transmitted to the computing device via a data bus. This advantageously enables information to be used as operating information, which is measured, for example, by different sensors and/or by different control units in the motor vehicle during the operation of the motor vehicle. For example, data can be accessed in this way that are determined by an engine control unit, a transmission control unit and/or by further sensors assigned to individual components of the drivetrain. By connecting the control units or the sensors to a data bus of the motor vehicle, for example a CAN bus, the information determined by the control units and/or by the sensors can be transmitted to the computing device as operating information and used for wear prediction.

A rotational speed, a torque, an oil pressure, an oil temperature, a speed, weather information describing a weather condition, and any combination thereof, can be used according to the disclosure as operating information. Operating information can include a plurality of these parameters, in particular a plurality of parameters that can be assigned to a single component. In addition to this, the operating information can also include data which describe a general operating state of the motor vehicle, such as the speed of the motor vehicle, an engaged gear or a weather condition, such as air humidity or a temperature, prevailing in the surroundings of the motor vehicle. A speed or a torque can be determined, for example, for a drive motor of the motor vehicle or can also be determined at other components of the motor vehicle, such as a propeller shaft, a differential gear, a clutch or the like. An oil pressure and/or an oil temperature of a drive motor and/or a transmission can also be used as operating information. The respective operating information can be assigned to an operating state of the component and allow conclusions to be drawn about the loads acting on the component in the operating state. For example, a high engine speed at a low outside temperature and an engine oil temperature, which currently still corresponds to the outside temperature, may indicate a high load and the associated faster wear of the engine or an engine component, whereas a low engine speed when the engine oil is at operating temperature and a moderate speed of the motor vehicle can represent a lower load condition of the motor vehicle, which is correspondingly associated with an expected wear of the engine or an engine component that is not as fast.

In some embodiments, in the case of wear information describing an increased state of wear of a component that a corresponding indication can be transmitted to a display device of the motor vehicle and/or that corresponding repair information of the computing device is transmitted to an external data processing device via a wireless communication connection. An increased state of wear of a component can be determined, for example, by comparing current operating information to reference information and/or by comparing comparison information created using operating information, which, for example, contains continuously accumulated operating information. If such an increased state of wear is present, the driver can be informed of the increased state of wear of the component by giving a corresponding indication on a display device of the motor vehicle, so that he can, if necessary, adapt his driving style and/or, if necessary, consider visiting a workshop. Additionally or alternatively, it is possible that in the event of a state of increased wear of a component, corresponding repair information is transmitted to an external data processing device, for example in a workshop, via a wireless communication link. For example, it is possible that an appointment has already been reserved in the workshop and/or an order for a spare part for the worn component has already been made in order to make a workshop visit of the motor vehicle as short as possible. In particular, it can be provided that a condition in which the component has reached, for example, 95% of a maximum permissible design spectrum, is considered to be an increased state of wear, so that the component can be replaced before a defect associated with the complete wear of the component occurs.

In some embodiments, the at least one item of operating information and/or wear information is transmitted from the computing device via a communication link to an external display device, in particular a laptop, a tablet or a smartphone. The communication link can be wireless or via a cable. Provision can be made for the operating information and/or the wear information to be transmitted in the form of a report which reflects the state or degree of wear of the individual components of the drivetrain of the motor vehicle. A user, for example the driver of the motor vehicle or a mechanic, can thus assess the state of the drivetrain of the motor vehicle. It is also possible for additional information to be transmitted, for example information about the expected repair costs and/or the spare parts, working hours or the like necessary for the repair. The transmission to the external display device makes it particularly advantageously possible to obtain an overview of the condition of the drivetrain of the motor vehicle without having to carry out a visual inspection of the drivetrain components, which for the most part are accessible only with considerable effort.

For a motor vehicle according to the disclosure, it is provided that it comprises at least one drivetrain having at least one component, at least one sensor and a computing device, the computing device being configured to carry out a method according to the disclosure.

Further advantages and details of the present disclosure will become apparent from the following exemplary embodiments and with reference to the drawings.

FIG. 1 shows a side view of a motor vehicle 1 according to the disclosure. The motor vehicle comprises a drivetrain 2, which is made up of a plurality of components. The following are shown as components of the drivetrain 2: a drive motor 3, a transmission 4, a cardan shaft 5 and a differential transmission 6 arranged on the rear axle. The drivetrain 2 can of course include other components such as shafts, joints, couplings or the like. The drive motor 3 can be, for example, an internal combustion engine, which is coupled to the transmission 4 to drive the motor vehicle 1. The drive motor 3 comprises a control unit 7 and a sensor 8, both the control unit 7 and the sensor 8 each being designed to determine at least one item of operating information describing an operating state of the drive motor 8. Correspondingly, the transmission 4 comprises a control unit 9 and a sensor 10, and the differential gear 6 a control unit 11.

The sensors 8, 10 and the control units 7, 9, 11 assigned to the respective components are connected to a data bus 12 of the motor vehicle 1. The operating information determined by the control units 7, 9, 11 and the sensors 8, 10 can be transmitted to a computing device 13 of the motor vehicle via the data bus 12. The computing device 13 can be designed, for example, as a control unit and/or can be integrated in a control unit connected to the data bus 12. The motor vehicle 1 further comprises a speed sensor 14 and a weather sensor 15, which generates weather information describing the weather. In addition to this, further sensors can be provided which are also designed to transmit operating information to the computing unit 13 via the data bus 12. The computing unit 13 can receive the operating information transmitted to it and assigned to the individual components of the drivetrain and compare the operating information and/or comparison information generated based on the operating information to reference information stored in the computing device. Depending on this comparison, the computing device 13 generates wear information describing wear of the respective component. Depending on the wear information, the computing device can control a display device 16 of the vehicle to display a message and/or use a communication link 17 to transmit repair information to an external data processing device and/or to transfer the at least one item of operating information and/or the wear information to an external display device.

For example, a torque and/or a speed determined by the engine control unit 7, an oil temperature measured by the sensor 8, a torque determined by the transmission control unit or a speed of the transmission, an oil temperature in the transmission measured by the sensor 10, and/or a torque and/or a speed of the differential gear measured by the control unit 11 of the differential gear can be used as operating information. In addition, operating information can also include further information, for example a speed of the motor vehicle determined by the speed sensor 14, and/or weather information determined by the weather sensor 15, such as an ambient temperature or humidity, which describes the weather.

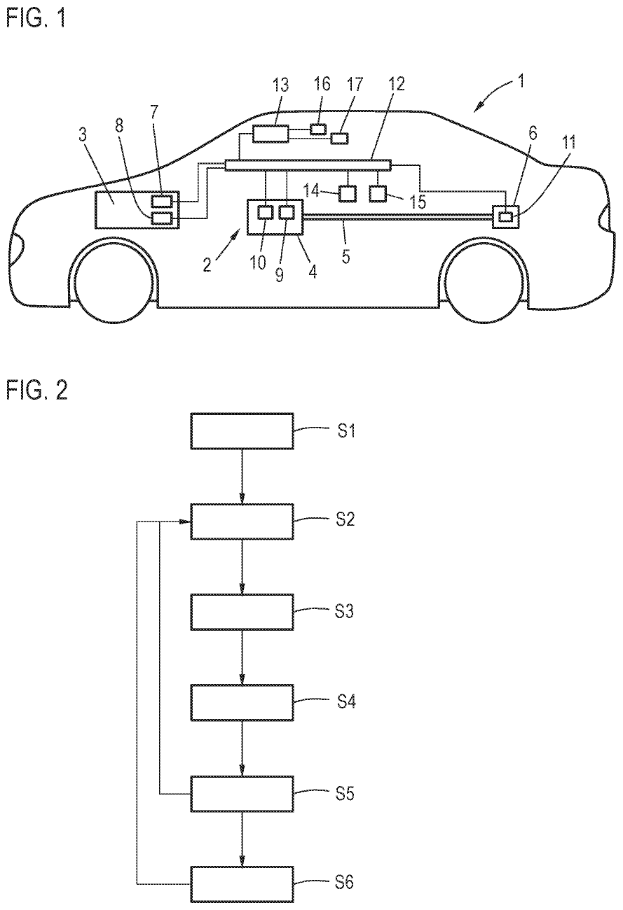

FIG. 2 shows a block diagram of an exemplary embodiment of a method according to the disclosure. The steps describe:

| | |
|---|---|
| S1 | Begin |
| S2 | Transmission of the operating information to |
| | the computing device |
| S3 | Classification, summation and storage as load |
| | spectrum information |
| S4 | Comparison of the load spectrum information |
| | to the reference information |
| S5 | Generation of wear information |
| S6 | Display and/or transmission of wear information |

The method starts in step S1 with the start of operation of the motor vehicle. The method can be started, for example, as soon as an ignition of the motor vehicle is actuated or, for example in the case of a vehicle with electrical operation, as soon as a movement of the motor vehicle takes place.

In step S2, operating information determined by a control unit 7, 9, 11 and/or a sensor 8, 10 is transmitted from the respective control unit and/or sensor determining the operating information via the data bus 12 to the computing device 13.

In step S3, the operating information transmitted to the computing device 13 is classified, added up depending on the classification and stored as a load spectrum. For example, a weighting of the operational information can be used depending on the classification during the adding up. For example, a high load operating state, for example operating information that describes a high speed or a high torque, can be weighted more heavily than a low speed or a low torque. The load spectrum information is then stored in the computing device 13.

In step S4, the comparison between the load spectrum information stored in the computing device 13 and the reference information stored in the computing device 13 takes place. The reference information may, for example, have been specified by the manufacturer of the motor vehicle and describes the maximum load which the component in question can withstand before such wear occurs which makes it necessary to replace the component.

Depending on the outcome of this comparison, wear information is generated in step S5. This wear information indicates, for example, how far the total load exerted up to this point on the component and described by the load spectrum information still is from the maximum possible total load stored as reference information. If there is no wear, new operating information is transmitted to the control unit, classified and added to the already stored load spectrum information and stored as new load spectrum information.

If it is determined in step S5 that a component is worn or that a component is expected to wear soon, so that a replacement of the component is necessary in the near future, then in step S6 a corresponding message can be issued via the display device 16 to a driver of the motor vehicle 1. Additionally or alternatively, corresponding repair information may also be transmitted to a data processing device, for example in a workshop, via the communication link 17. In this case too, the method is then continued in step S2 with the transmission of new operating information to the control unit. The method can be ended, for example, by the operating state of the vehicle ending, for example by switching off an ignition and/or by locking a central locking system or the like.

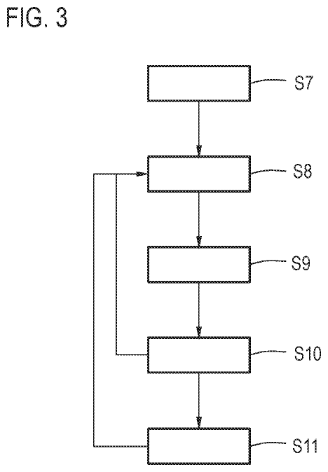

FIG. 3 shows a block diagram of a further exemplary embodiment of a method according to the disclosure. The steps are labeled as follows:

| | |
|---|---|
| S7 | Begin |
| S8 | Transmission of a frequency spectrum as operating |
| | information to the computing device |
| S9 | Comparison to a reference spectrum |
| S10 | Generation of wear information |
| S11 | Transmission and/or display of wear information |

The method starts in step S7 under the conditions already mentioned in relation to step S1. Finally, in step S8, a frequency spectrum is transmitted to the computing device as operating information. The frequency spectrum can be a structure-borne sound signal and/or airborne sound signal derived from a sensor assigned to the respective component. For example, the frequency spectrum can be determined by Fourier transformation of the received sensor signal, it being possible, for example, to use a Fast Fourier Transformation (FFT).

In step S9, the frequency spectrum transmitted to the computing device 13 is compared to a reference spectrum stored as reference information in the computing device 13 for the currently prevailing operating state of the motor vehicle. In step S9, for example, a comparison can be made with regard to amplitude changes at discrete frequencies. This comparison makes it possible to recognize an acute or sudden wear of a component, since, for example, the wear of a moving component of the drivetrain can result in a changed sound radiation and thus a changed frequency spectrum. For example, an imbalance in a bearing or an insufficient fill level of a lubricant can be recognized in this way.

In step S10, wear information is generated depending on the comparison made in step S9 that indicates, for example, whether there is acute wear or whether the recorded frequency spectrum with the reference spectrum stored in the computing device 13 shows sufficient accuracy of correspondence, so that it can be concluded that there is no wear on the component in question. Analogously to the method described in FIG. 2, when there is current wear, wear information is output via the display device 16 of the motor vehicle and/or the corresponding repair information is transmitted to an external data processing device via the communication link 17 and/or to an external display device.

Subsequently, a new frequency spectrum is transmitted to the computing device in step S8. The method can run as long as the motor vehicle 1 is still in operation. When the operation of motor vehicle 1 ends, the method according to the disclosure is likewise ended accordingly.

In some embodiments, the method described in relation to FIG. 2 and the method described in relation to FIG. 3 run simultaneously, so that at least one quantity describing a load on the component and a frequency spectrum which is measured on the component is transmitted as operational information. It is also possible for the computing device 13 to carry out one or both of these methods for a part or for all components of the drivetrain.

It can further be provided that the wear information stored in the computing device 13 and assigned to the respective components is transmitted via the communication link 17 to an external device of a user, such as a driver of the motor vehicle or a mechanic, and can be viewed there by the user. The user can thus get an overview of the state of wear of the individual components of the drivetrain 2 of the motor vehicle 1 without the need for a visual inspection of the respective components.

1.-11. (canceled)

12. A method for predicting wear of a drivetrain of a motor vehicle, comprising:
recording, by a sensor of the motor vehicle, an operating information describing an operating state of a component of the drivetrain;
transmitting, to a computing device of the motor vehicle, the operating information for different points in time during operation of the motor vehicle;
classifying, by the computing device, the operating information;
summing up and storing the operating information in the computing device as a load spectrum information, wherein the load spectrum information is used as a comparison information;
comparing the operating information and/or the comparison information to a reference information stored in the computing device; and
generating a wear information describing the wear of the component of the drivetrain depending on the comparison.

13. The method according to claim 12, further comprising:
using a design spectrum information describing a maximum load on the component of the drivetrain as the reference information.

14. The method according to claim 12, further comprising:
determining a frequency spectrum of the component of the drivetrain as the operating information; and
using a reference spectrum assigned to an operation of the component as the reference information.

15. The method according to claim 14, further comprising:
determining, by a Fourier transformation, the frequency spectrum from a sensor signal assigned to the component; and
comparing the frequency spectrum to the reference spectrum based on amplitude changes at discrete frequencies.

16. The method according to claim 15, wherein determining the frequency spectrum comprises using a Fast Fourier Transformation (FFT).

17. The method according to claim 15, further comprising:
using a structure-borne noise signal, and/or an airborne noise signal as the sensor signal.

18. The method according to claim 12, wherein transmitting the operating information comprises transmitting to the computing device via a data bus.

19. The method according to claim 12, further comprising:
using a rotational speed, a torque, an oil pressure, an oil temperature, a speed, a weather information describing weather conditions, and/or any combination thereof, as the operating information.

20. The method according to claim 12, further comprising:
transmitting a corresponding indication to a display device of the motor vehicle if the wear information describes an increased state of wear of the component.

21. The method according to claim 12, further comprising:
transmitting a corresponding repair information from the computing device via a wireless communication link to an external data processing device.

22. The method according to claim 12, further comprising:
transmitting the operating information and/or the wear information from the computing device via a communication link to an external display device, wherein the external display device comprises a laptop, a tablet, or a smartphone.

23. A motor vehicle with a drivetrain, comprising:
a sensor configured to record an operating information describing an operating state of a component of the drivetrain; and
a computing device configured to:
transmit the operating information for different points in time during operation of the motor vehicle;
classify the operating information;
store the operating information as a load spectrum information, wherein the load spectrum information is used as a comparison information;
compare the operating information and/or the comparison information to a reference information stored in the computing device; and
generate a wear information describing the wear of the component of the drivetrain depending on the comparison.

24. The motor vehicle of claim 23, wherein the sensor is further configured to record a design spectrum information describing a maximum load on the component of the drivetrain, wherein the design spectrum information is used as the reference information.

25. The motor vehicle of claim 23, wherein the sensor is further configured to record a frequency spectrum of the component of the drivetrain as the operating information, the frequency spectrum is compared with a reference spectrum assigned to an operation of the component.

26. The motor vehicle of claim 25, wherein the frequency spectrum is determined, by a Fourier transformation, from a sensor signal assigned to the component, wherein the frequency spectrum is compared to the reference spectrum with regard to amplitude changes at discrete frequencies.

27. The motor vehicle of claim 26, wherein the sensor signal is a structure-borne noise signal, and/or an airborne noise signal.

28. The motor vehicle of claim 23, wherein the operating information is transmitted to the computing device via a data bus.

29. The motor vehicle of claim 23, wherein the operating information comprises a rotational speed, a torque, an oil pressure, an oil temperature, a speed, a weather information describing weather conditions, and/or any combination thereof.

30. The motor vehicle of claim 23, further comprising:
a display device configured to receive a corresponding indication if the wear information describes an increased state of wear of the component.

31. The motor vehicle of claim 23, wherein the computing device is further configured to transmit a corresponding repair information via a wireless communication link to an external data processing device.
